(19) United States
(12) Patent Application Publication
(10) Pub. No.: US 2013/0187469 A1
(43) Pub. Date: Jul. 25, 2013

(54) REDUNDANT POWER SUPPLY UPS MODULE

(71) Applicants: Chien-Ta Liang, New Taipei City (TW); Wei-Cheng Huang, New Taipei City (TW)

(72) Inventors: Chien-Ta Liang, New Taipei City (TW); Wei-Cheng Huang, New Taipei City (TW)

(21) Appl. No.: 13/353,332

(22) Filed: Jan. 19, 2012

(51) Int. Cl. H02J 9/00

(52) U.S. Cl. 307/66

(57) ABSTRACT

The redundant power supply UPS module for an electronic system contains at least a first power supply electrically connected to an external AC power source and converting the AC electricity from the AC power source to DC electricity for powering the electronic system; at least a second power supply; a battery electrically connected to the second power supply for providing DC electricity to the second power supply; and a control module electrically connected to the first and second power supplies and capable of detecting the stored electricity of the battery and power interruption from the AC power source, and capable of controlling the charge and discharge of the battery.

### TECHNICAL FIELD OF THE INVENTION

The present invention is generally related to uninterrupted power provision, and more particular to an uninterrupted power supply module having redundant and hot pluggable power supplies.

### DESCRIPTION OF THE PRIOR ART

A server computer is usually equipped with two or more power supplies so as to keep the server running in case one of the power supplies fails. However, when there is a black out, an uninterrupted power supply (UPS) system is required to maintain the operation of the server. Yet, a high-power UPS system is costly and consumes a lot of space. The battery in the UPS system is short-lived and also constantly requires maintenance.

### SUMMARY OF THE INVENTION

Therefore, a redundant power supply UPS module for an electronic system is provided herein for obviating the foregoing shortcomings.

A major objective of the present invention is to provide an UPS module having redundant and hot pluggable power supplies.

A second objective of the present invention is to provide a structurally simple, low-cost, and low-volume redundant power supply UPS module.

Yet another objective of the present invention is to provide a long-lived and highly reliable redundant power supply UPS module.

To achieve the objectives, the redundant power supply UPS module contains at least a first power supply electrically connected to an external AC power source and converting the AC electricity from the AC power source to a DC electricity for powering the electronic system; at least a second power supply; a battery electrically connected to the second power supply for providing a DC electricity to the second power supply; and a control module electrically connected to the first and second power supplies and capable of detecting the stored electricity of the battery and power interruption from the AC power source, and capable of controlling the charge and discharge of the battery.

Preferably, the DC electricity from the first power supply is adapted and charged to the battery.

Preferably, the battery is a Lithium battery.

Preferably, the first power supply is hot pluggable, meaning that the operation of the UPS module is not affected when the first power supply is unplugged.

Preferably, the first power supply is hot pluggable.

Preferably, the control module is capable of detecting whether the power supplies are plugged or unplugged.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a functional block diagram showing a redundant power supply UPS module according an embodiment of the present invention.

FIG. 2 is a flow diagram showing a charging mode of a redundant power supply UPS module according to the present invention.

FIG. 3 is a flow diagram showing a discharging mode of a redundant power supply UPS module according to the present invention when there is a black out.

FIG. 4 is a flow diagram showing a discharging mode of a redundant power supply UPS module according to the present invention when a first power supplied is unplugged.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

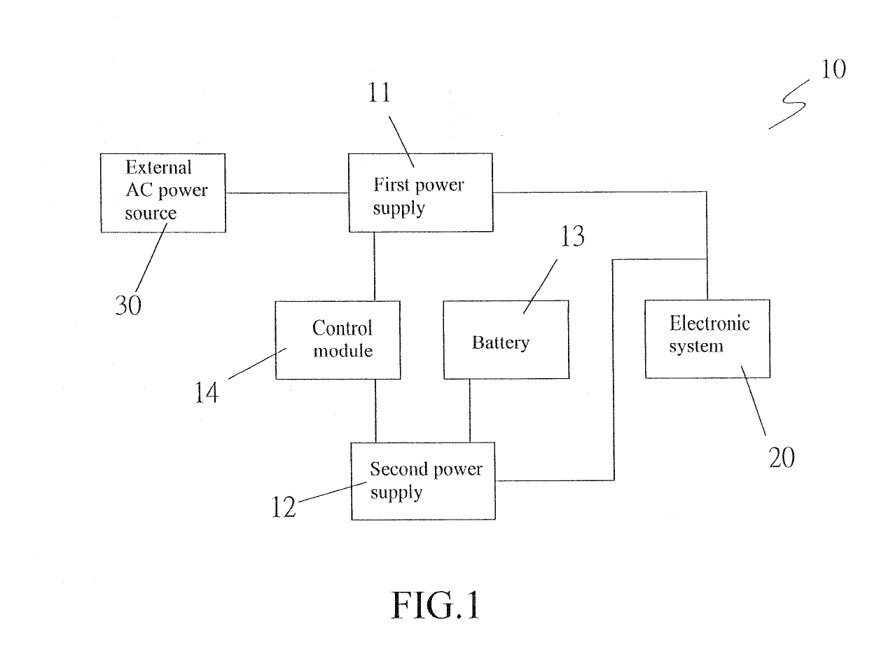

As illustrated by the functional blocks of FIG. 1, a redundant power supply UPS module 10 for the provisioning of uninterrupted power to an electronic system 20 according to an embodiment of the present invention contains at least a first power supply 11 is electrically connected to an external AC power source 30 and converts the AC electricity from the AC power source 30 to a DC electricity for the electronic system 20; at least a second power supply 12; a battery 13 electrically connected to the second power supply 12 for providing a DC electricity to the second power supply 12; and a control module 14 electrically connected to the first and second power supplies 11 and 12 and capable of detecting the stored electricity of the battery 13 and power interruption from the AC power source 30, and capable of controlling the charge and discharge of the battery 13.

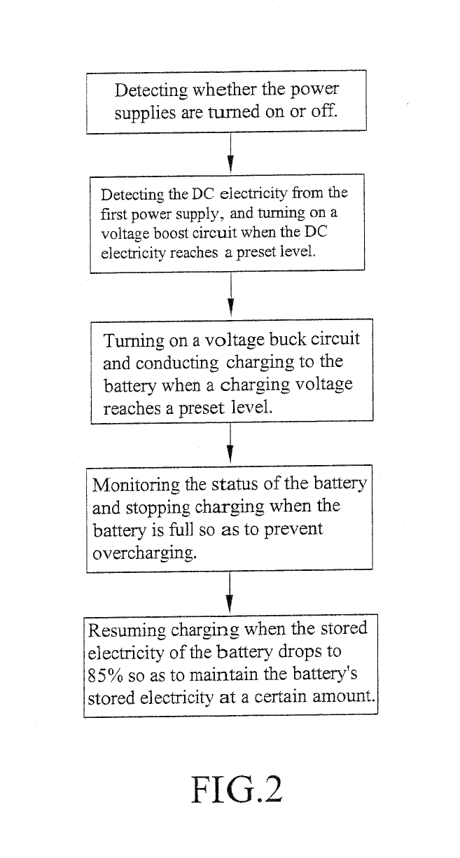

As shown in the flow diagram of FIG. 2, the charging mode of the present invention is as follows. The control module 14 detects whether the power supplies are turned on or off. If the power supplies are turned on, the control module 14 detects the DC electricity from the first power supply 11. When the DC electricity reaches a preset level, the control module 14 turns on a voltage boost circuit. When a charging voltage reaches a preset level, the control module 14 turns on a voltage buck circuit and conducts charging to the battery 13. The control module 14 continuously monitors the status of the battery 13 and stops charging when the battery 13 is full so as to prevent overcharging. When the stored electricity of the battery 13 drops to 85%, the control module 14 resumes charging so as to maintain the battery 13′s stored electricity at a certain amount.

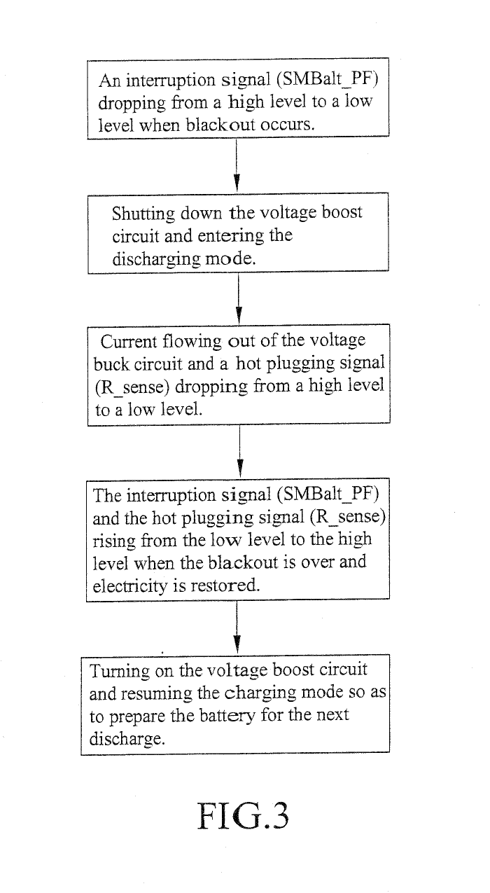

As shown in the flow diagram of FIG. 3, the discharging mode of the present invention when there is a black out is as follows. The blackout causes an interruption signal (SMBalt_PF) to drop from a high level to a low level. After detecting such a scenario, the control module 14 shuts down the voltage boost circuit and enters the discharging mode. Then, there would be current flowing out of the voltage buck circuit and a hot plugging signal (R_sense) would drop from a high level to a low level. When the blackout is over and electricity is restored, the interruption signal (SMBalt_PF) rises from the low level to the high level and the hot plugging signal (R_sense) also rises from the low level to the high level. The control module 14 turns on the voltage boost circuit and resumes the charging mode so as to prepare the battery 13 for the next discharge.

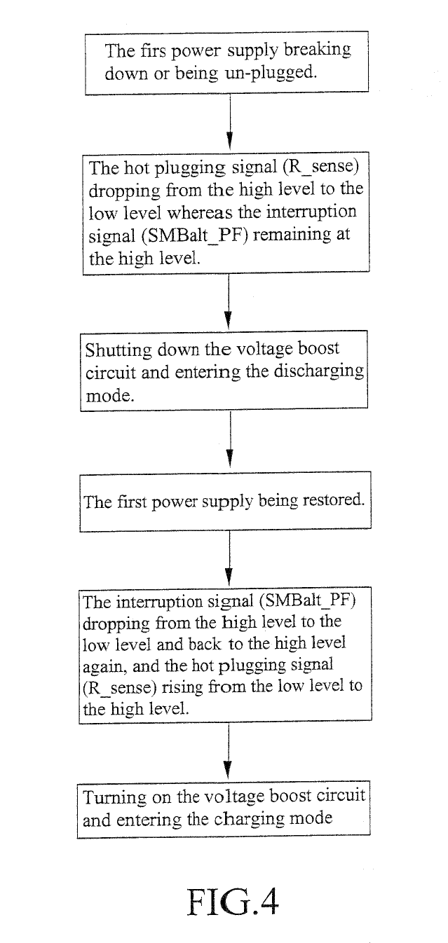

As shown in the flow diagram of FIG. 4, the discharging mode of the present invention when the first power supply 11 is unplugged is as follows. When the firs power supply 11 breaks down or is un-plugged, the hot plugging signal (R_sense) drops from the high level to the low level whereas the interruption signal (SMBalt_PF) remains at the high level. The control module 14 shuts down the voltage boost circuit and enters the discharging mode. When the first power supply 11 is restored, he interruption signal (SMBalt_PF) drops from the high level to the low level and back to the high level again. The hot plugging signal (R_sense) rises from the low level to the high level. The control module 14 turns on the voltage boost circuit and enters the charging mode.

The advantages of the present invention are as follows.

Firstly, the present invention uses the battery 13 as the backup power source which is charged by the DC electricity from the power supplies. There is no additional AC-DC conversion circuit. The design is simpler and consumes less space compared to the prior art.

Secondly, the present invention is capable of detecting black out and supports hot plugging redundancy. When there is a black out or the first power supply 11 breaks down or unplugged, the battery 13 takes over in time to continuously provide electricity to the electronic system 20 so that there is still time to conduct file saving or data backup on the electronic system 20.

Thirdly, as the present invention consumes less space, it can be housed in an ordinary power supply enclosure. It therefore can be used to replace one or both of the two ordinary power supplies of a conventional server computer.

Fourthly, the battery 13 can be a Lithium battery for a longer operational life.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A redundant power supply UPS module for an electronic system, comprising:
at least a first power supply electrically connected to an external AC power source and converting the AC electricity from said AC power source to a DC electricity for powering said electronic system;
at least a second power supply;
a battery electrically connected to said second power supply for providing a DC electricity to said second power supply; and
a control module electrically connected to said first and second power supplies and capable of detecting the stored electricity of said battery and power interruption from said AC power source, and capable of controlling the charge and discharge of said battery.

2. The redundant power supply UPS module according to claim 1, wherein said DC electricity from said first power supply is adapted and used to charge said battery.

3. The redundant power supply UPS module according to claim 1, wherein battery is a Lithium battery.

4. The redundant power supply UPS module according to claim 1, wherein said first power supply is hot pluggable; and, when said first power supply is unplugged, the operation of said redundant power supply UPS module is not affected.

5. The redundant power supply UPS module according to claim 1, wherein said second power supply is hot pluggable; and, when said second power supply is unplugged, the operation of said redundant power supply UPS module is not affected.

6. The redundant power supply UPS module according to claim 1, wherein said control module is capable of detecting whether said power supplies are plugged or unplugged.
